(19) United States
(12) Patent Application Publication
(10) Pub. No.: US 2012/0109871 A1
(43) Pub. Date: May 3, 2012

(54) REPRODUCING APPARATUS AND METHOD, AND COMPUTER PROGRAM

(75) Inventors: Takao Sawabe, Tokyo (JP); Nobuyuki Takakuwa, Tokyo (JP); Yasuko Fukuda, Tokyo (JP)

(73) Assignee: PIONEER CORPORATION, Kanagawa (JP)

(21) Appl. No.: 13/383,315

(22) PCT Filed: Jul. 14, 2009
(86) PCT No.: PCT/JP2009/062725

§ 371 Date: Jan. 10, 2012

(51) Int. Cl. G06N 5/02

(52) U.S. Cl. 706/48

(57) ABSTRACT

A reproducing apparatus (100) is provided with: a detecting device (102) for detecting, when one title out of a plurality of titles is reproduced, a title unbound application associated with another title out of the plurality of titles under the condition that the one title is composed of a BD-J object; and an executing device (102) for executing the detected title unbound application. According to the reproducing apparatus, even if the one title is reproduced without reproducing another title which is to be reproduced before the one title, the title unbound application associated with the other application is executed. Thus, it is possible to appropriately reproduce the one title.

### TECHNICAL FIELD

The present invention relates to a reproducing apparatus and method capable of reproducing a Blu-ray disc, and a computer program.

### BACKGROUND ART

On this type of apparatus, for example, linkage reproduction for reproducing video data while executing a Java (registered trademark, the same shall apply hereinafter) application is performed in many cases. Incidentally, the video data and the Java application which are to be linked correspond to each other by a reproduction unit referred to a “title”.

As this type of apparatus, for example, a patent document 1 describes a reproducing apparatus wherein package information is generated by combining files recorded on a Blu-ray Disc Read Only Memory (BD-ROM) and files recorded on a hard disk in accordance with merge administration information, one of a plurality of reproducible titles is selected as a current title on the basis of the package information, and a digital stream is reproduced in accordance with playlist information indicated by the current title while an application associated with the current title is executed.

Here in particular, the patent document 1 describes that if the updating of the merge management information is required by that the executed application designates new merge management information, the new package information is generated by combining the files recorded on the BD-ROM and the files recorded on the hard disk in accordance with the newly designated merge management information when the reproduction of the digital stream is stopped by changing the current title.

Alternatively, a patent document 2 describes a reproducing apparatus wherein if, after a first input for specifying one title is received from a user, a second input for specifying another title is received within a predetermined time, then, the first input is invalidated, and if there is no third input within a predetermined time after the reception of the second input, an application is started on the basis of the second input.

### PRIOR ART DOCUMENT

### Patent Document

Patent document 1: Japanese Translation of PCT International Application (TOKUHYO) No. 2008-507795
Patent document 2: International Publication WO2006/028132

### DISCLOSURE OF INVENTION

### Subject to be Solved by the Invention

Here, in the Java application, there are a title bound application which is a Java application that can exist only in a reproduced title, and a title unbound application which is a Java application that can exist throughout a plurality of titles.

For example, in a case where one title recorded on the Blu-ray disc is automatically reproduced without waiting for an instruction from a user, if there is the title unbound application which is started in another title to be reproduced before the one title, there is a possibility that the one title cannot be appropriately reproduced, which is technically problematic. In the technologies described in the patent documents 1 and 2 described above, it is extremely hard to solve the aforementioned technical problem, which is also technically problematic.

In view of the aforementioned problems, it is therefore an object of the present invention to provide a reproducing apparatus and method capable of appropriately reproducing one title without waiting for an instruction from a user, and a computer program.

### Means for Solving the Subject

The above object of the present invention can be achieved by a reproducing apparatus provided with: a detecting device for detecting, when one title out of a plurality of titles is reproduced, a title unbound application associated with another title out of the plurality of titles under the condition that the one title is composed of a BD-J (Blu-ray Disc Java) object; and an executing device for executing the detected title unbound application.

According to the reproducing apparatus of the present invention, the detecting device, which is provided, for example, with a memory, a processor and the like, detects, when the one title out of the plurality of titles is reproduced, the title unbound application associated with the another title out of the plurality of titles under the condition that the one title is composed of the BD-J object,.

The expression that “the one title is composed of the BD-J object” means that a Java application can be executed in the one title. Moreover, the “title unbound application associated with another title” means the title unbound application started when the another title is reproduced.

Incidentally, the another title may be all the titles other than the one title out of the plurality of titles, or may be one portion of the titles other than the one title out of the plurality of titles. If the another title is one portion of the titles other than the one title out of the plurality of titles, it is desirable that the another title includes a title corresponding to a First Play and a title corresponding to a Menu.

For example, the executing device, which is provided, for example, with a memory, a processor and the like, executes the detected title unbound application. Specifically, for example, the executing device executes the detected title unbound application before the one title is actually reproduced after the one title is selected.

According to the study of the present inventors, the following matter is revealed. For example, in a case where titles are reproduced in ascending order from the title number of each of titles, if the one title is reproduced, not only the title bound application and the title unbound application associated with the one title but also the title unbound application associated with another title reproduced before the one title are also executed.

Thus, if the one title is reproduced without reproducing another title which is to be reproduced before the one title, there is a possibility that the title unbound application to be originally executed is not executed. As a result, during the reproduction of the one title, for example, a process of performing graphic display at a predetermined time point by the title unbound application, a communication between the title unbound application and the title bound application, and the like are interrupted, and the one title likely cannot be appropriately reproduced.

However, in the present invention, the title unbound application associated with the another title out of the plurality of titles is detected by the detecting device under the condition that the one title is composed of the BD-J object when the one title out of the plurality of titles is reproduced. Then, by the executing device, the detected title unbound application is executed.

Therefore, even if the one title is reproduced without reproducing another title which is to be reproduced before the one title, the title unbound application associated with the another application is executed. Thus, it is possible to appropriately reproduce the one title.

Specifically, for example, on the reproducing apparatus of the present invention, even if a title corresponding to a main story is reproduced as the one title without a user's instruction regarding a title to be reproduced (e.g. the title corresponding to the main story) with reference to a displayed menu (in other words, even if the title corresponding to the main story is reproduced without the reproduction of the title corresponding to the menu), the title unbound application associated with the title corresponding to the menu as the another title is executed. Thus, the title corresponding to the main story is appropriately reproduced. As a result, it is possible to reduce a user's operation load, which is very useful in practice.

In one aspect of the reproducing apparatus of the present invention, it is further provided with a judging device for judging whether or not the one title is composed of the BD-J object.

According to this aspect, it is possible to judge whether or not the one title is composed of the BD-J object, relatively easily. Thus, it is very useful in practice.

In another aspect of the reproducing apparatus of the present invention, the another title includes a title corresponding to a First Play and a title corresponding to a Menu.

According to this aspect, the another title includes the title corresponding to each of the First Play and the Menu, which is highly likely reproduced before the one title. Thus, even if the another title is one portion of the titles other than the one title out of the plurality of titles, it is possible to appropriately reproduce the one title.

In another aspect of the reproducing apparatus of the present invention, the plurality of titles are included in files recorded on a Blu-ray disc, or a file structure obtained by integrating the files recorded on the Blu-ray disc and files recorded on a recording medium which is different from the Blu-ray disc.

According to this aspect, the reproducing apparatus targets at not only the files recorded on the Blu-ray disc but also the file structure (i.e. a virtual file system) obtained by integrating the files recorded on the Blu-ray disc and the files recorded on the recording medium which is different from the Blu-ray disc (e.g. a hard disk, etc.). In particular, since the virtual file system is a reproduction target, for example, the updated (i.e. latest or newest) Java application or the like can be executed, which is very useful in practice.

In this aspect, it may be further provided with a selecting device for selecting the one title, under the condition that main story title number information corresponding to creator information associated with the Blu-ray disc is recorded, on the basis of the recorded main title number information.

By virtue of such configuration, it is possible to reproduce the title corresponding to the main story, relatively easily.

The “creator information associated with the Blu-ray disc” means information indicating the creator of the Blu-ray disc (e.g. a person who has a copyright associated with contents recorded on the Blu-ray disc) or information specifying the disc. The creator information is included, for example, in an index table file. The “main story title number information” means information indicating the title number applied to the title corresponding to the main story.

According to the study of the present inventors, the following matter is revealed. For example, the title number applied to the title can be arbitrarily applied by the creator, regardless of the content of the title. On the other hand, in the Blu-ray disc produced by the same creator, the title number is highly likely applied in accordance with a predetermined rule. Moreover, if a user watches the contents recorded on the Blu-ray disc, the user highly likely watches the main story, for example, rather than special contents (e.g. a preview, etc.)

Therefore, if the one title is selected on the basis of the main story title number information, it is possible to increase the possibility that the selected one title is the main story. Moreover, in a case where the one title included in the Blu-ray disc or the virtual file system is automatically reproduced without waiting for an instruction from the user, if the reproduced title is the main story, it does not provide any uncomfortable feeling to the user. Thus, it is very useful in practice.

The above object of the present invention can be also achieved by a reproducing method provided with: a detecting process of detecting, when one title out of a plurality of titles is reproduced, a title unbound application associated with another title out of the plurality of titles under the condition that the one title is composed of a BD-J object; and an executing process of executing the detected title unbound application.

According to the reproducing method of the present invention, it is possible to appropriately reproduce the one title, as in the reproducing apparatus of the present invention.

Incidentally, even the reproducing method of the present invention can adopt the same various aspects as those of the reproducing apparatus of the present invention.

The above object of the present invention can be also achieved by a computer program for making a computer function as a reproducing apparatus comprising: a detecting device for detecting, when one title out of a plurality of titles is reproduced, a title unbound application associated with another title out of the plurality of titles under the condition that the one title is composed of a BD-J object; and an executing device for executing the detected title unbound application.

According to the computer program of the present invention, the reproducing apparatus of the present invention described above can be relatively easily realized as the computer reads and executes the computer program from a recording medium for storing the computer program, such as a ROM, a CD-ROM, a DVD-ROM, and a hard disk, or as it executes the computer program after downloading the program through a communication device. By this, it is possible to appropriately reproduce the one title, as in the reproducing apparatus of the present invention.

Incidentally, even the computer program of the present invention can adopt the same various aspects as those of the reproducing apparatus of the present invention.

As explained above, according to the reproducing apparatus of the present invention, it is provided with the detecting device and the executing device. According to the reproducing method of the present invention, it is provided with the detecting process and the executing process. According to the computer program of the present invention, it makes a computer function as the reproducing apparatus described above. Thus, it is possible to appropriately reproduce the one title.

The operation and other advantages of the present invention will become more apparent from the embodiment explained below.

### BRIEF DESCRIPTION OF DRAWINGS

FIG. 1 is a block diagram showing the structure of a reproducing apparatus in an embodiment of the present invention.

FIG. 2 is a conceptual view showing one example of the file structure of a Blu-ray disc in the embodiment of the present invention.

FIG. 3 is a conceptual view showing one example of the file structure of a local storage in the embodiment of the present invention.

FIG. 4 is a conceptual view showing one example of the file structure of a virtual file system in the embodiment of the present invention.

FIG. 5 is a conceptual view showing one example of an index table file in the embodiment of the present invention.

FIG. 6 is a conceptual view showing one example of a BD-J object file in the embodiment of the present invention.

FIG. 7 is a flowchart showing the operations of the reproducing apparatus in the embodiment of the present invention.

### MODE FOR CARRYING OUT THE INVENTION

Hereinafter, an embodiment of the reproducing apparatus of the present invention will be explained with reference to the drawings.

(Structure of Reproducing Apparatus)

Firstly, the structure of a reproducing apparatus in this embodiment will be explained with reference to FIG. 1. FIG. 1 is a block diagram showing the structure of the reproducing apparatus in the embodiment. Incidentally, arrows in FIG. 1 show a signal flow.

In FIG. 1, a reproducing apparatus 100 is provided with a title information/user input part 101, a system controller 102, a local storage 104, a memory 105, a servo circuit 106, a spindle motor 107, an optical pickup 108, a demodulator 109, a demultiplexer 110, a video decoder 111, an audio decoder 112, and a sub picture decoder 113. Incidentally, the “local storage 104” in the embodiment is one example of the “recording medium” of the present invention.

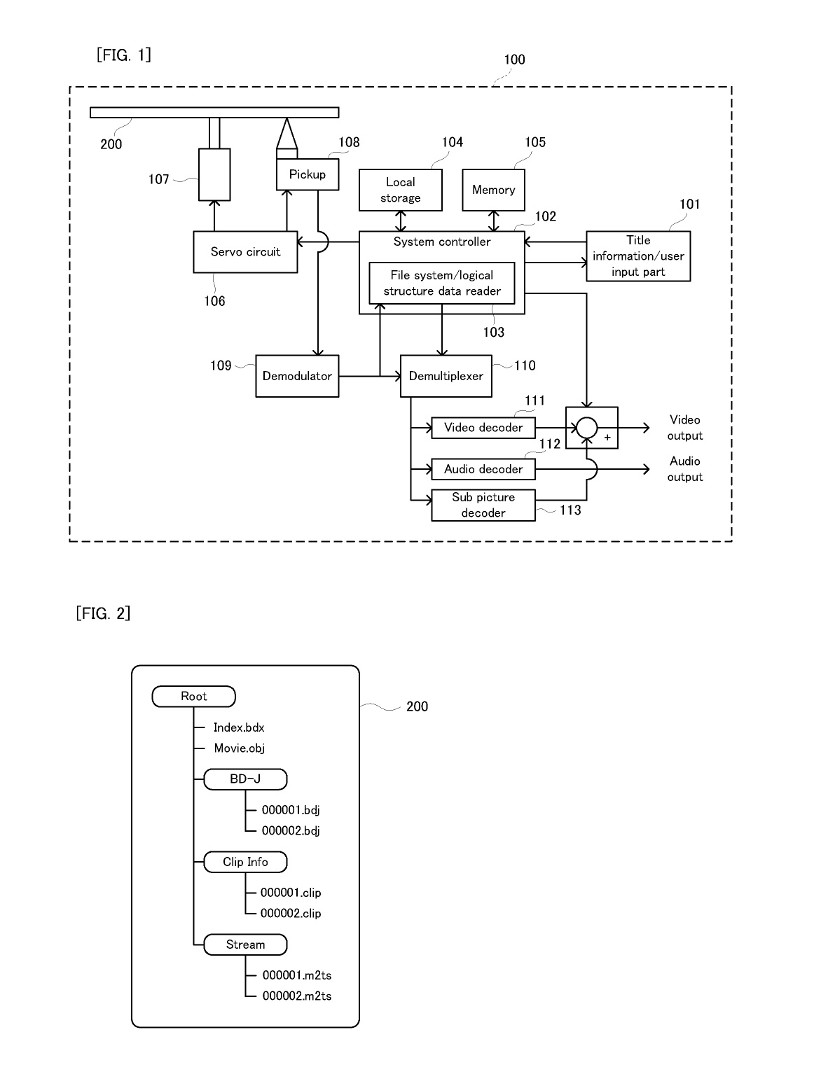

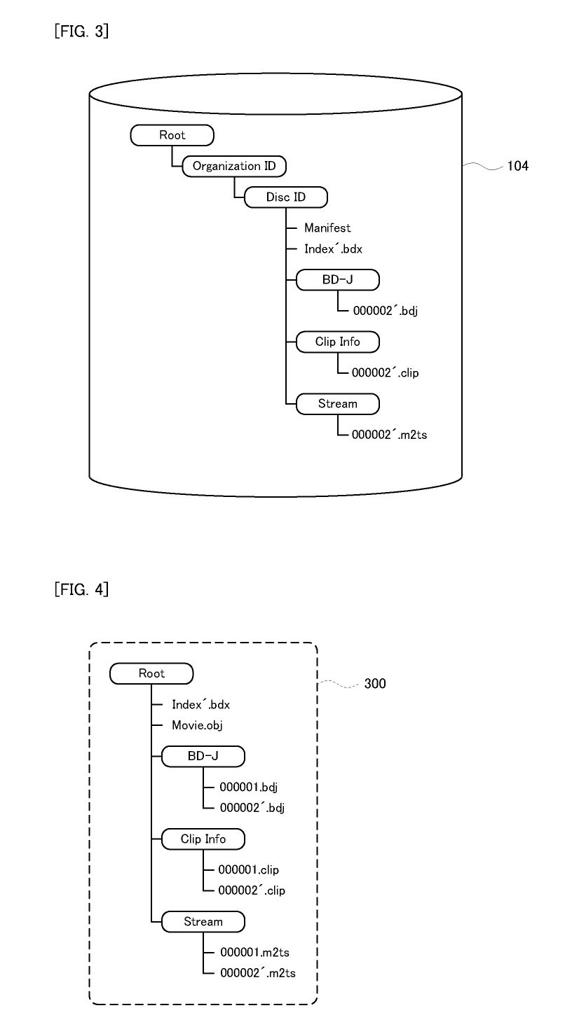

Now, the file structure of a Blu-ray disc 200 is, for example, as shown in FIG. 2; namely, under a Root directory, there are a BD-J directory, a Clip Info directory, and a Stream directory. FIG. 2 is a conceptual view showing one example of the file structure of the Blu-ray disc in the embodiment.

In the BD-J directory, a BD-J object file is stored. In the Clip Info directory, a clip info file is stored. Incidentally, the clip info file is a file for holding attribute information about a stream recorded in the clip info file. In the Stream directory, a stream file is stored.

In the local storage 104 such as, for example, a hard disk, sub contents which can be used with contents recorded on the Blu-ray disc 200 are recorded. Specifically, for example, if the contents recorded on the Blu-ray disc 200 are movie contents, then, subtitle data, dubbing data, and the like are recorded in the local storage 104. Incidentally, the sub contents recorded in the local storage 104 are typically obtained from a server disposed on a network via a not-illustrated communication part.

The sub contents obtained from the server disposed on the network (hereinafter referred to as “updated data” as occasion demands) are divided in the directories on each corresponding Blu-ray disc 200 and are recorded.

Now, the file structure of the local storage 104 is, for example, as shown in FIG. 3; namely, under the Root directory, there is an Organization ID directory, and under the Organization ID directory, there is a Disc ID directory. FIG. 3 is a conceptual view showing one example of the file structure of the local storage in the embodiment.

Incidentally, the directory name of the Organization ID directory is a name indicating information for identifying, for example, the provider of the contents recorded on the Blu-ray disc 200 and the manufacturer of the Blu-ray disc. Moreover, the directory name of the Disc ID directory is a name indicating information for identifying, for example, the Blu-ray disc on which special contents are recorded.

Incidentally, although the illustration is omitted in FIG. 3, there are a plurality of Organization ID directories each of which responds to respective one of a plurality of organizations. In the same manner, there are a plurality of Disc ID directories each of which responds to respective one of a plurality of Blu-ray discs.

It is assumed that the Disc ID directory shown in FIG. 3 corresponds to the Blu-ray disc 200 shown in FIG. 2. The updated data corresponding to the Blu-ray disc 200 is recorded under the Disc ID directory shown in FIG. 3. “Index'.bdx”, “000002′.bdj”, “000002′.clip”, and “000002′.m2ts” shown in FIG. 3 are the updated data of “Index.bdx”, “000002.bdj”, “000002.clip”, and “000002.m2ts” shown in FIG. 2, respectively. Incidentally, a Manifest file in FIG. 3 is a file in which management information about the updated data is stored.

As described above, the updated data recorded in the local storage 104 is data obtained correspondingly to any of the contents recorded on the Blu-ray disc 200. The updated data is recorded into the local storage 104, for example, in the reproduction of the contents recorded on the Blu-ray disc 200.

The reproducing apparatus 100 can not only reproduce the contents recorded on the Blu-ray disc 200 but also reproduce the updated data recorded in the local storage 104 with the contents recorded on the Blu-ray disc 200. In this case, the reproducing apparatus 100 establishes a virtual file system 300 (refer to FIG. 4) in which the files recorded on the Blu-ray disc 200 and the files associated with the updated data recorded in the local storage 104 are integrated, thereby performing a reproduction process. By virtue of the reproduction process based on the virtual file system, the same reproduction as that in a reproduction process from one medium can be performed. FIG. 4 is a conceptual view showing one example of the file structure of the virtual file system in the embodiment.

(Operations of Reproducing Apparatus)

Back in FIG. 1 again, the system controller 102 controls the reproduction of the Blu-ray disc 200 on the basis of signals for indicating a title to be reproduced, a reproduction condition, and the like, which are transmitted from the title information/user input part 101. Specifically, the system controller 102 controls the optical pickup 108 to read information recorded on the Blu-ray disc 200 while controlling the spindle motor 107 to rotate the Blu-ray disc 200 at a predetermined rotation frequency via the servo circuit 106.

A pickup read signal, which is a signal indicating the information read by the optical pickup 108, is transmitted to the demodulator 109 and is demodulated by the demodulator 109. The demodulator 109 transmits signals indicating demodulated data to the system controller 102 and the demultiplexer 110. Incidentally, the signal indicating the demodulated data associated with a logical information file (e.g. “Index.bdx” in FIG. 2, etc.) is transmitted to the system controller 102, and the signal indicating the demodulated data associated with clip data (e.g. “000001.m2ts” and “000002.m2ts” in FIG. 2, etc.) is transmitted to the demultiplexer 110.

The file system/logical structure data reader 103 of the system controller 102 extracts logical information file data from the received signal indicating the demodulated data. The system controller 102 determines a reproduction address on the basis of the extracted logical information file data and controls each of the spindle motor 107 and the optical pickup 108 via the servo circuit 106.

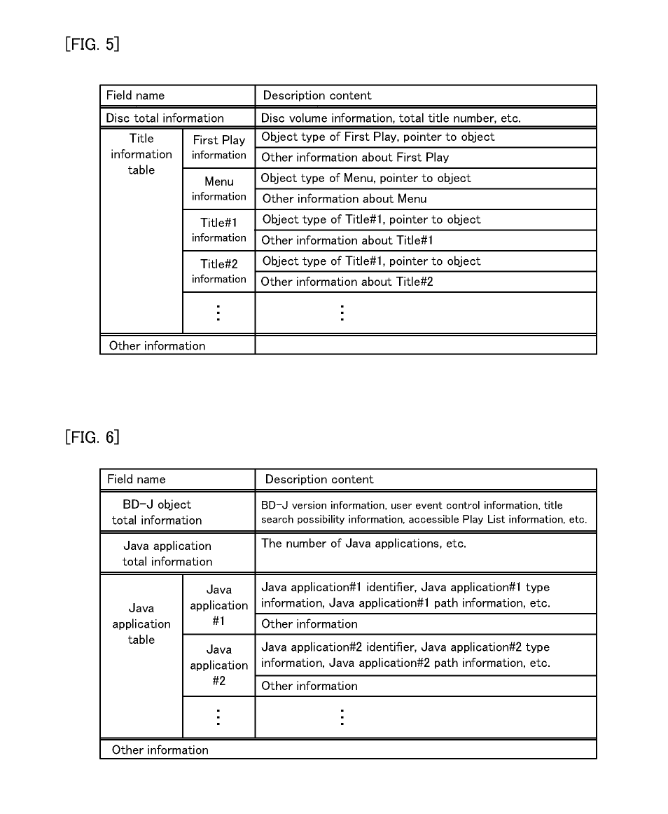

Then, the system controller 102 obtains the object type of the title to be reproduced, and a pointer to an object, with reference to an index table file (i.e. “Index.bdx”) shown in FIG. 5. FIG. 5 is a conceptual view showing one example of the index table file in the embodiment.

If the object type of the title to be reproduced is a Movie object, the system controller 102 transfers a reproduction environment to a Movie object reproduction environment. Then, the system controller 102 obtains a Movie object file (e.g. “Movie.obj” in FIG. 2) from the obtained pointer to the object, and sequentially executes commands in the obtained Movie object file.

In the Movie object reproduction environment, if a playlist reproduction command is executed, the system controller 102 obtains playlist information and play item information which are designated, and determines a stream to be reproduced. Then, the system controller 102 obtains reproduction start position information with reference to an address conversion table stored in the clip info file (e.g. “000001.clip” in FIG. 2, etc.).

If ending access to a reproduction position address indicated by the reproduction start position information, the system controller 102 controls the demultiplexer 110 to start the decoding of each elementary stream. As a result, video and audio are reproduced. At this time, the system controller 102 combines a sub picture with video output in predetermined timing and outputs it.

On the other hand, if the object type of the title to be reproduced is a BD-J object, the system controller 102 reads, for example, Java Virtual Machine or the like stored in the memory 105 and transfers the reproduction environment to a Java runtime environment. Then, the system controller 102 obtains the BD-J object file (e.g. “000001.bdj” in FIG. 2, etc.) from the obtained pointer to the object.

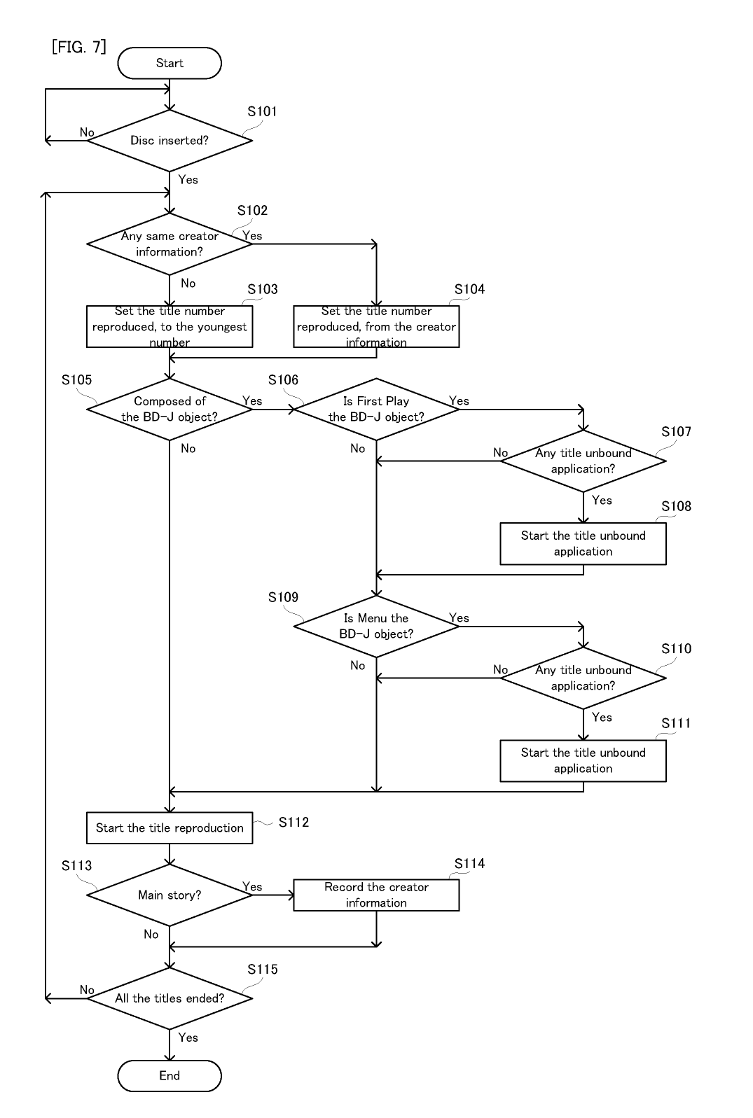

Then, the system controller 102 executes an application program with reference to Java application #x path information in accordance with predetermined priority (e.g. top four on a Java application table in the BD-J object file as shown in FIG. 6, etc.). FIG. 6 is a conceptual view showing one example of the BD-J object file in the embodiment.

In the Java runtime environment, if playlist reproduction is instructed from the Java application, the system controller 102 obtains the playlist information and the play item information which are designated, and determines the stream to be reproduced. Then, the system controller 102 obtains the reproduction start position information with reference to the address conversion table stored in the clip info file.

If ending the access to the reproduction position address indicated by the reproduction start position information, the system controller 102 controls the demultiplexer 110 to start the decoding of each elementary stream. As a result, the video and the audio are reproduced.

Incidentally, if the updated data is recorded in the local storage 104, for example, the followings may be performed; namely, the system controller 102 displays a menu which allows a user to select whether or not the updated data is used when the Blu-ray disc 200 is inserted in the reproducing apparatus 100. If the user selects the use of the updated data, the system controller 102 establishes the virtual file system 300 and performs the reproduction process based on the established virtual file system 300.

Incidentally, the system controller automatically establishes the virtual file system 300 and performs the reproduction process based on the established virtual file system 300 when the Blu-ray disc 200 is inserted in the reproducing apparatus 100.

Particularly in the embodiment, if the Blu-ray disc 200 is inserted in the reproducing apparatus 100, the reproducing apparatus 100 reproduces one title out of a plurality of titles without waiting for an instruction from the user. Incidentally, the reproduced one title is not limited to what is included in the Blu-ray disc 200 but may be included in the virtual file system 300.

When the one title is reproduced, the system controller 102 detects a title unbound application associated with another title (e.g. a title corresponding to a First Play and a title corresponding to a Menu) out of the plurality of titles, under the condition that the one title is composed of the BD-J object (i.e. the object type of the one title is the BD-J object). Then, the system controller 102 executes the detected title unbound application. Then, the system controller 102 reproduces the one title.

As a result, according to the reproducing apparatus 100, even if the one title is reproduced without reproducing another title which is to be reproduced before the one title, the title unbound application associated with the another title is executed. Thus, it is possible to appropriately reproduce the one title.

Incidentally, the “system controller 102” in the embodiment is one example of the “detecting device” and the “executing device” of the present invention.

Next, the operations of the reproducing apparatus 100 in the case where the Blu-ray disc 200 is inserted in the reproducing apparatus 100 will be explained, specifically, with reference to the flowchart in FIG. 7.

In FIG. 7, firstly, the system controller 102 judges whether or not the Blu-ray disc 200 is inserted in the reproducing apparatus 100 (step S101). If it is judged that the Blu-ray disc 200 is not inserted in the reproducing apparatus 100 (the step S101: No), the system controller 102 performs the process in the step S101 again.

On the other hand, if it is judged that the Blu-ray disc 200 is inserted in the reproducing apparatus 100 (the step S101: Yes), the system controller 102 judges whether or not creator information indicating the same creator as a creator associated with the inserted Blu-ray disc 200 (i.e. the provider of the contents recorded on the Blu-ray disc 200 and the manufacturer of the Blu-ray disc) is recorded in the local storage 104 (step S102).

Here, in the creator information, for example, the name of a creator, the title number of a title corresponding to a main story, and the like are stored. Incidentally, the creator information is stored, for example, in the Organization ID directory (refer to FIG. 3) in the local storage 104.

Incidentally, if the updated data is used, for example, the system controller 102 establishes the virtual file system 300 before the process in the step S102 after the judgment that the Blu-ray disc 200 is inserted in the process in the step S101.

If it is judged that the creator information is not recorded (the step S102: No), the system controller 102 selects a title to which the smallest title number is applied, as one title, out of titles which have not reproduced yet (step S103). On the other hand, if it is judged that the creator information is recorded (the step S102: Yes), the system controller 102 selects the one title on the basis of the title number of the title corresponding to the main story stored in the creator information as one example of the “main story title number information” of the present invention (step S104).

Then, the system controller 102 judges whether or not the selected one title is composed of the BD-J object (step S105). If it is judged that the one title is not composed of the BD-J object (i.e. the object type of the one title is the Movie object) (the step S105: No), the system controller 102 reproduces the selected one title (step S112).

On the other hand, if it is judged that the one title is composed of the BD-J object (the step S105: Yes), the system controller 102 judges whether or not a title corresponding to a First Play is composed of the BD-J object (step S106).

If it is judged that the title corresponding to the First Play is composed of the BD-J object (the step S106: Yes), the system controller 102 judges whether or not the title unbound application is included in the title corresponding to the First Play (step S107). If it is judged that the title unbound application is included (the step S107: Yes), the system controller 102 starts the included title unbound application (step S108).

Then, the system controller 102 judges whether or not the title corresponding to the Menu is composed of the BD-J object (step S109). Incidentally, even in the process in the step S106, if it is judged that the title corresponding to First Play is not composed of the BD-J object (the step S106: No), and in the process in the step S107, if it is judged that the title unbound application is not included (the step S107: No), the system controller 102 performs the process in the step S109.

If it is judged that the title corresponding to the Menu is composed of the BD-J object (the step S109: Yes), the system controller 102 judges whether or not the title unbound application is included in the title corresponding to the Menu (step S110). If it is judged that the title unbound application is included (the step S110: Yes), the system controller 102 starts the included title unbound application (step S111).

Then, the system controller 102 reproduces the selected one title (step S112). Incidentally, even in the process in the step S109, if it is judged that a title corresponding to a Menu is not composed of the BD-J object (the step S109: No), and in the process in the step S110, if it is judged that the title unbound application is not included (the step S111: No), the system controller 102 performs the process in the step S112.

Incidentally, in the embodiment, regarding the title corresponding to the First Play and the title corresponding to the Menu, it is judged whether or not the title is composed of the BD-J object and whether or not the title unbound application is included. Even regarding another title, it may be judged whether or not the title is composed of the BD-J object and whether or not the title unbound application is included.

Then, the system controller 102 judges whether or not the reproduced title is the title corresponding to the main story (step S113). Incidentally, whether or not it is the title corresponding to the main story may be judged, for example, by judging whether or not the reproducing apparatus 100 goes into a state of waiting for the user's input in a predetermined time, or whether or not the reproduction has been performed for a predetermined time or more.

If it is judged that the reproduced title is the title corresponding to the main story (the step S113: Yes), the system controller 102 records the creator information into the local storage 104 (step S114). Incidentally, if the creator information has been already recorded in the local storage 104, the already recorded creator information may be updated, or it may be recorded into the local storage 104 as new creator information.

Then, the system controller 102 judges whether or not all the titles are reproduced (step S115). Incidentally, even in the process in the step S113, if the reproduced title is not the title corresponding to the main story (the step S113: No), the system controller 102 performs the process in the step S115.

If it is judged that all the titles are reproduced (the step S115: Yes), the process operations are ended once. On the other hand, if it is judged that all the titles are not reproduced (the step S115: No), the system controller 102 performs the process in the step S102. Here, if the creator information recorded in the local storage 104 is the same as the creator information in the previous loop, the system controller 102 typically skips the process in the step S102 and performs the process in the step S103.

Incidentally, the “system controller 102” in the embodiment is one example of the “judging device” and the “selecting device” of the present invention.

The present invention is not limited to the aforementioned embodiment, but various changes may be made, if desired, without departing from the essence or spirit of the invention which can be read from the claims and the entire specification. A reproducing apparatus and method, and a computer program, which involve such changes, are also intended to be within the technical scope of the present invention.

### DESCRIPTION OF REFERENCE CODES

100 reproducing apparatus
102 system controller
104 local storage
105 memory
106 servo circuit
107 spindle motor
108 optical pickup
200 Blu-ray disc

1. A reproducing apparatus comprising:
a detecting device for detecting, when one title out of a plurality of titles is reproduced before one or more titles to be reproduced before the one title, a title unbound application associated with another title out of the plurality of titles under the condition that the one title is composed of a BD-J object; and
an executing device for executing the detected title unbound application.

2. The reproducing apparatus according to claim 1, further comprising a judging device for judging whether or not the one title is composed of the BD-J object.

3. The reproducing apparatus according to claim 1, wherein the another title includes a title corresponding to a First Play and a title corresponding to a Menu.

4. The reproducing apparatus according to claim 1, wherein the plurality of titles are included in files recorded on a Blu-ray disc, or a file structure obtained by integrating the files recorded on the Blu-ray disc and files recorded on a recording medium which is different from the Blu-ray disc.

5. The reproducing apparatus according to claim 4, further comprising a selecting device for selecting the one title, under the condition that main story title number information corresponding to creator information associated with the Blu-ray disc is recorded, on the basis of the recorded main title number information.

6. A reproducing method comprising:
a detecting process of detecting, when one title out of a plurality of titles is reproduced before one or more titles to be reproduced before the one title, a title unbound application associated with another title out of the plurality of titles under the condition that the one title is composed of a BD-J object; and
an executing process of executing the detected title unbound application.

7. (canceled)
